(19) United States
(12) Patent Application Publication
(10) Pub. No.: US 2013/0093361 A1
(43) Pub. Date: Apr. 18, 2013

(54) Method for Operating a Semiconductor Lighting Device and Color Control Device for Carrying Out the Method

(71) Applicants: Ralph Bertram, Nittendorf (DE); Tobias Frost, Burglengenfeld (DE); Stefan Lorenz, Obertraubling (DE)

(72) Inventors: Ralph Bertram, Nittendorf (DE); Tobias Frost, Burglengenfeld (DE); Stefan Lorenz, Obertraubling (DE)

(21) Appl. No.: 13/704,950

(22) PCT Filed: Jun. 8, 2011
(86) PCT No.: PCT/EP11/59476

§ 371 Date: Dec. 17, 2012

(30) Foreign Application Priority Data
Jun. 15, 2010 (DE) 102010030061.6

(51) Int. Cl. H05B 37/02

(52) U.S. Cl. CPC H05B 37/02
USPC 315/312

(57) ABSTRACT

A method for operating a semiconductor lighting device, wherein the semiconductor lighting device comprises semiconductor light sources having at least two different colors and wherein, in order to adjust a color coordinate of the semiconductor lighting device, at least one brightness of the semiconductor light sources is set by means of a control and wherein the at least one brightness of the semiconductor light sources is adjusted by at least two controls, and wherein, upon reaching or exceeding at least one predetermined switchover point, a switchover is made between two of the controls.

The invention relates to a method for operating a semiconductor lighting device, wherein the lighting device comprises semiconductor light sources having at least two different colors and wherein, in order to adjust a color coordinate of the semiconductor lighting device, a brightness of the semiconductor light sources is set by means of a control or an algorithm respectively. The invention further relates to a color control device for carrying out the method.

A color temperature can be a measure of a color sensation of a light source. The color temperature can in particular be defined as the temperature of a black body, a Planck's radiator, which belongs to a specific light color of this radiation source. Specifically, it can be the temperature indicator which, with the same brightness and under determined observation conditions, is the most similar to the color described (CCT: “correlated color temperature”, most similar color temperature). In a chromaticity diagram (e.g. a CIE 1931 diagram), a white point of this type of lighting belongs to each color temperature of a light source. The spectral distribution of the light from radiators with the same color temperature can differ very considerably (referred to as “metameric light sources”). Light from metameric light sources can comprise a continuous spectrum or be restricted to a number of narrow spectral bands. A color reproduction index indicates the quality of the color reproduction with regard to illumination from a light source.

The light color can be defined as the spectral composition of light which is emitted from a light source. Visible light evokes a color stimulus. The light color can be composed either of discrete individual colors, each of a specific wavelength, a mixture of several wavelengths or wavelength ranges, or of a continuous mixture of light of all wavelengths of a specific spectral range. Light can comprise a continuous spectrum if, like sunlight or the light from an incandescent lamp, it derives from an incandescent body. Its spectrum then follows the laws of the Planck's (black) radiator. The light color can then be determined by the wavelength of the maximum of the continuous spectrum and be allocated to a corresponding color temperature, measured in Kelvin, which is equal to the temperature of the radiating incandescent body. The light color already begins immediately above the absolute zero point with the heat radiation in the far infra-red. The higher the temperature is, the shorter the wavelengths emitted, and, in consequence, the “bluer” the maximum becomes.

With a lighting device which produces its “white” light color by way of the color mixture of different colored light sources, in particular light-emitting diodes (LED's), the cumulative color (color of the mixed light) must be controlled by the relative intensity of the light sources. The cumulative color of two light sources lies in this situation on the straight connecting lines of the two color coordinates of the light sources in the CIE color diagram. This distinguishes between bichromatic systems of assemblages with three or more different (primary) light colors, with which the cumulative color coordinate of the mixed light can be selected more freely, although it is also more difficult to stabilize.

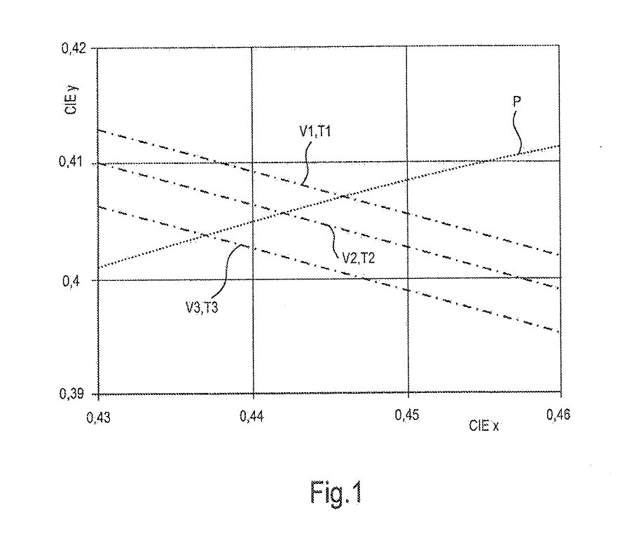

FIG. 1 shows an extract from the CIE color diagram with several straight connecting lines V1, V2, V3 for two LED's or groups of LED's with different colors (bichromatic mixed light). The two (groups of) LED's change their color coordinate in various different operating conditions (e.g. dependent on a temperature, a means of actuation, and its age). The straight connecting lines V1, V2, V3 shown change under different operating states, and are differentiated in this situation by the temperature T1, T2, or T3 respectively of the (otherwise identical) LED's. The temperatures correspond in this case, for example, to T1<40° C., T2=80° C., and T3=100° C., which corresponds to a typical temperature range of an LED. The change of the color coordinate (e.g. with a changing temperature T) therefore takes place not only in the direction of the straight connecting lines V1, V2, V3. In consequence, a constant cumulative color coordinate is practically unattainable. Despite controlling, therefore, the cumulative color coordinate is always dependent on an operational state of the two LED's or groups of LED's, and lies on the existing or current straight connecting lines V1, V2, V3 between the two current LED color coordinates. If the LED brightnesses are changed (e.g. by another LED current or a pulse width modulation) or also during the warm-up phase, the LED operating state will also change, and therefore the straight connecting lines V1, V2, V3 of the LED color coordinates. Accordingly, another actuation (e.g. in order to reach a color coordinate on the current straight line) leads to a new straight connecting line, which may possibly no longer contain the original target color coordinate. The Planck's plot curve P is marked in as a broken line.

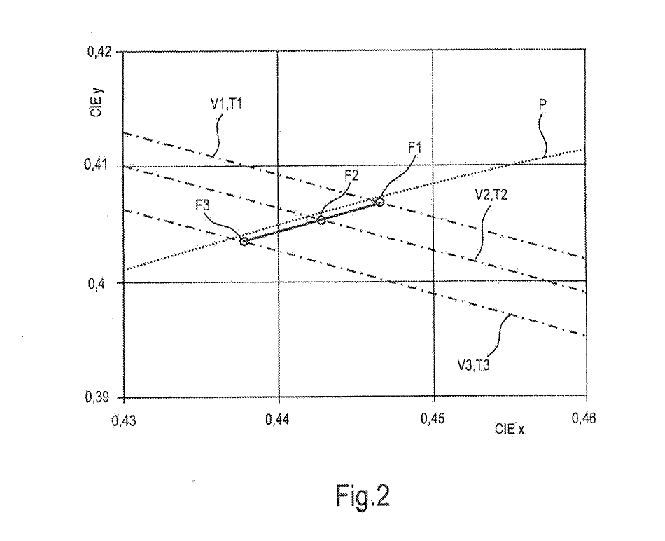

The intensity of the LED's can be adjusted to different target specifications for the color coordinate, in particular controlled. For a particularly natural appearance, the color coordinate can be controlled in such a way, for example, that it lies on the Planck's plot curve (“Planck Control”). A possible control or a possible control algorithm for the cumulative color coordinate can therefore comprise the concept that, depending on the LED temperature T, a brightness ratio of the different-colored LED's or LED groups is adjusted in such a way that the cumulative color coordinate F1, F2, F3 lies on the Planck's plot curve or close to it. In this respect, FIG. 2 shows, drawn in as circles, the adjusted color coordinates F1, F2, F3 on the pertinent straight connecting lines V1, V2, V3 for the temperatures T1, T2, T3. A color coordinate F1, F2, F3 close to the Planck's plot curve comes closest to natural light from thermal light sources, and each color coordinate F1, F2, F3 on the Planck's plot curve corresponds to a black body temperature. However, the color coordinate F1, F2, F3 adjusted in this way ranges very widely over different LED operating states (in this case, the temperature T), with the result that, disadvantageously, a perceptible color change is visible.

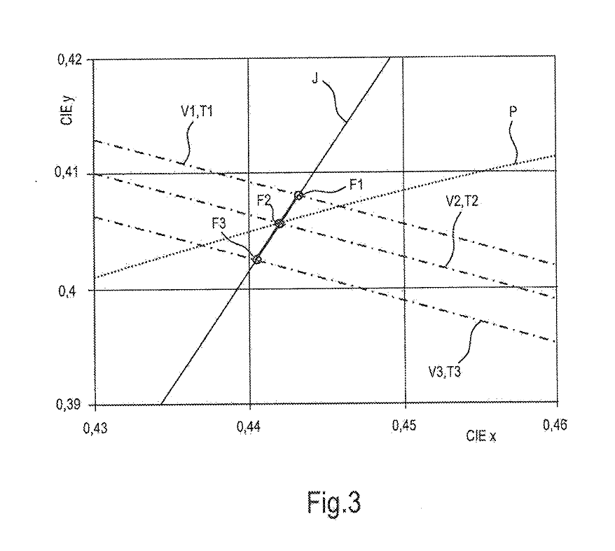

For a minimum color temperature fluctuation (e.g. fluctuation of the equivalent color temperature), the color coordinates F1, F2, F3 can be adjusted in such a way that they lie on a straight Judd line J (i.e. at a constant color temperature; “Judd Control”), as shown in FIG. 3. Depending on the LED temperature T, the brightness ratio can therefore be adjusted in such a way that the cumulative color coordinate F1, F2, F3 lies on the straight Judd line with constant correlated color temperature (CCT). A disadvantage here is that the cumulative color coordinate deviates substantially from the natural effect of the Planck's plot curve, and, in consequence, presents a visible color deviation.

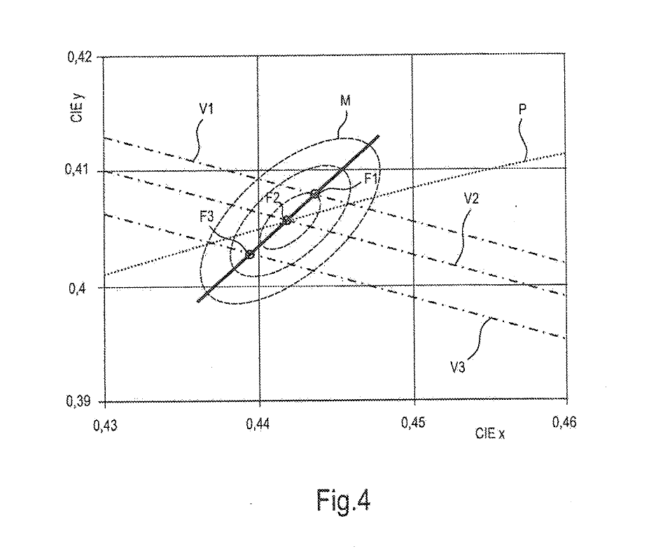

For a minimum visible color deviation, the color coordinates F1, F2, F3 are adjusted in such a way that they range along the large semi-axis of a MacAdam ellipse M, as shown in FIG. 4 (“MacAdam Control”). The term MacAdam ellipse can be used to designate, in particular, that area in a chromaticity diagram, in particular a CIExy diagram, around a reference color tone in which comparison colors are perceived as being equidistant. Depending on the LED temperature T, the brightness ratio can therefore be adjusted in such a way that the cumulative color coordinate F1, F2, F3 lies on a semi-axis, in particular the large semi-axis, of a MacAdam ellipse. The correlated color temperature (CCT) changes slightly in this situation, while the distance interval to the Planck's plot curve changes substantially.

V1, V2, V3 are general examples of a continuous row of straight connecting lines, which are formed by the mutually independent operational states of the individual LED's. Likewise, F1, F2, F3 are also examples from a continuous body of color coordinates.

Overall, compromises must be accepted with regard to the adjustment of the color coordinate (cumulative color coordinate) in respect of naturalness, color constancy, and color temperature constancy.

The adjustment of the color coordinate or cumulative color coordinate can be carried out, for example, by means of at least one characteristic curve or a reference table, from which, for a known temperature T of the LED(s), the electrical currents and/or the duty factors of the LED's can be determined which are required for an adjustment of the desired color coordinate at the temperature T. As an alternative, or in addition, a light sensor can be provided, by means of which the current color coordinate of the mixed light can be measured, wherein the color coordinate measured can be used as an actual value for an adjustment to a reference value of the color coordinate. The use of brightness sensors for the individual LED's and a calculation of the cumulative color coordinate is also possible.

The object of the present invention is to overcome at least in part the disadvantages of the prior art and, in particular, to provide an improved possibility for the adjustment of a color coordinate of a mixed light of a lighting device with two separately controllable light sources or groups thereof, with different colors.

This object is achieved in accordance with the features of the independent claims. Preferred embodiments can be derived in particular from the dependent claims.

The object is achieved by a method for operating a semiconductor lighting device wherein the semiconductor lighting device comprises semiconductor light sources having at least two different colors, and wherein, to adjust a color coordinate of the semiconductor light sources, at least one brightness of the semiconductor light sources is adjusted by means of a control. The control (which is also designated as a control algorithm, control characteristic, or as an algorithm) can, in particular, correlate a desired color coordinate (cumulative color coordinate) of the lighting device with an actuation of the semiconductor light sources necessary for reaching the color coordinate under a current operating state. The control can, for example, be stored as a characteristic curve(s) or table. The control can, for example, be determined empirically.

The brightness of the semiconductor light sources is further adjusted by means of at least two controls, wherein, on reaching or exceeding at least one predetermined switchover point, a switchover is made between two of the controls. It is therefore possible to switch over dynamically between several controls or control characteristics. It is therefore possible to attain an optimized control or an optimized control behavior for different operational state ranges. The advantage is also derived from this that an adjustment of the color coordinate can be arranged in a variable manner, and an improved user appraisal is possible.

The switchover point can be switched on reaching or exceeding at least one predetermined switchover point. The switchover point can be a point of a value range of one or more parameters characterizing an operational state. The switchover point can in principle be reached or exceeded from smaller values to greater values of the value range (‘from the bottom up’), as well as from greater values to smaller values of the value range (‘from the top down’). It is possible to switch over between the controls also upon reaching or exceeding one switchover point from among several switchover points. In this situation a hysteresis can be used in order to avoid jump changes, as is described in greater detail hereinafter.

The reaching or exceeding of the switchover point between the controls is for preference recognized by the lighting device itself.

In one possible variant, the semiconductor lighting device comprises light sources with exactly two different colors (bichromatic semiconductor lighting device). In view of the fact that the adjustment of the color coordinate mainly involves an adjustment of a ratio of the brightnesses of the two colors, it may be sufficient that, to adjust a color coordinate of the semiconductor lighting device, brightness of only one of the semiconductor light sources (one color) is carried out, or, respectively, the control is fulfilled by means of a brightness adjustment of the semiconductor light sources of only one of the two colors. It may be advantageous, for the improved adjustment of the overall brightness of the semiconductor lighting device, that for the adjustment of a color coordinate of the semiconductor lighting device a brightness of the semiconductor light sources of both colors is carried out.

In a further possible variant, the semiconductor lighting device comprises light sources with more than two different colors. The color coordinate in the then at least three-dimensional color space can likewise be adjusted with the method described, applied, for example, several times or in several steps. It is therefore possible, with one semiconductor lighting device, for light sources with three different colors, for two colors to be displaced by means of the method onto their desired common cumulative color coordinate, and, subsequently, for the cumulative color coordinate and the third color to be adjusted by means of the method onto the final color coordinate. By analogy, this can be carried out for four and more colors. The method is applied in this situation directly for two colors, but can be applied interlinked or interlaced for more colors. The method can be carried out iteratively.

It is an embodiment of the invention that the controls are selected from a group which comprises:
a) An adjustment of the color coordinate of the semiconductor light source onto a position on a straight Judd line. As a result, the lighting device can be operated with a constantly correlated color temperature.
b) An adjustment of the color coordinate of the semiconductor light source onto a position on a semi-axis of a MacAdam ellipse, in particular a large semi-axis of the MacAdam ellipse. This allows the lighting device to be operated with equidistant color sensations.
c) An adjustment of the color coordinate of the semiconductor light source onto a position on the Planck's plot curve. This makes possible a color with a particularly natural effect.

It is also an embodiment of the invention that the switchover point correlates with a temperature at at least one of the semiconductor light sources (the operating temperature of the semiconductor light source), or, respectively, corresponds with such a temperature. As a result, it is possible, for example, for a temperature-dependent color drift of the semiconductor light source(s) to be more effectively compensated. In particular, a distinction can be made between a control for a warm-up phase of the lighting device and a control for a thermally full-intensity operating phase, which then allows for particularly flexible and observer-friendly color coordination controlling.

The switchover point can in particular correspond to an operating temperature, which represents a lower limit of a nominal operating temperature. As a result, it is possible, in a particularly simple manner, for different controls to be applied to the warm-up phase and to the thermally full-intensity operating phase. The nominal operating temperature can, for example, reach from 80° C. to 90° C. A preferred switchover point then corresponds to an operating temperature of approximately 80° C.

In consequence, an advantageous embodiment can be such that, with the heating of the semiconductor light source above a specific operating temperature (e.g. in a range from less than 40° C. to 90° C.), switchover takes place from a first control behavior to a second control behavior (for preference on reaching the nominal operating temperature), and the second control behavior is then retained for the lighting device which is switched on, for all temperature ranges.

A further embodiment is that the switchover point correlates with a color coordinate, in particular a cumulative color coordinate. As a result, the switchover can be carried out with particular optical precision. The color coordinate can be sensed, for example, by means of a light sensor arranged for this purpose.

A further embodiment is that the switchover is only carried out on reaching or exceeding in one direction. As a result, frequent switching back and forth between two controls can be avoided, since once the lighting device has reached or exceeded the switchover point it can be operated with the same control, and, specifically, also if the switchover point is reached or exceeded from the other direction.

It is also an embodiment of the invention that the switchover between two controllers is carried out once for the period during which the lighting device is switched on. As a result, it is possible in particular for the use of only one controller to be assured for the thermally full-intensity operating phase after a previous warm-up phase or another type of initial phase. After the lighting device has been switched off, it is again possible to switch over between the two controllers.

It is also an embodiment that the switchover is carried out on reaching the switchover point from both directions, or exceeding it in both directions (i.e. on reaching or exceeding the point from below as well as from above). This allows for the adjustment of the color coordinate to be particularly well adjusted to changes of at least one operating state.

It is a special embodiment that the switchover is carried out dependent on the direction in the event of there being different switchover points. By means of such a “hysteresis”, frequent switchover between two controllers can be avoided.

It is also an embodiment of the invention that the two switchover points form a hysteresis of approximately 5° C. to 10° C. As a result, in the event of switchover in both directions, with a still sufficiently finely defined switchover, frequent switching back and forth between two states, in the event of a switchover in both directions, can be avoided.

It is also an embodiment that the color coordinate is in the first instance adjusted to a position on the Planck's plot curve and, on reaching or exceeding a predetermined color temperature and/or the temperature at at least one of the semiconductor light sources, switchover takes place onto a position on a straight Judd line. This switchover can provide the advantage that, during a warm-up phase of the lighting device, it presents a color behavior similar to that of an incandescent lamp, and, only after reaching a predetermined operating temperature, in particular shortly before or upon reaching a nominal operating temperature (which lies, for example, between 80° C. and 90° C.), does it maintain a constant color temperature. In particular (if the switchover between the two controls is only carried out once for the duration of the lighting device being switched on), the color temperature can nevertheless thereafter remain constant at an operating temperature which is high or too low.

It is a further embodiment that the color coordinate is initially adjusted to a position on a semi-axis of a MacAdam ellipse, and, on reaching or exceeding a point of intersection with the Planck's plot curve, it is switched over to a position on a straight Judd line. This results in the advantage that, with the MacAdam Control, color changes are only visible once, e.g. at low operating temperatures of the LED(s) under the minimum nominal operating temperature of, for example, 80° C., but, after switching over to the Judd Control, the color temperature does not then rise at increased operating temperatures of, for example, over 80° C.

It is a further embodiment that switchover takes place between the two controls at an operating temperature at at least one of the semiconductor light sources shortly before reaching a nominal operating temperature range, in particular beginning at an operating temperature of above 80° C., in particular at approximately 80° C. As a result, a color coordinate of the lighting device can advantageously be adjusted by means of different controls for a thermally full-intensity operating phase and another operating phase, in particular a warm-up phase.

It is also an embodiment that the color coordinate is initially adjusted to a position on a semi-axis of a MacAdam ellipse and, on reaching or exceeding a point of intersection with the Planck's plot curve, is switched over onto a position (namely the straightest possible) on the Planck's curve. This allows the lighting device to be adjusted or controlled, for example, at low LED operating temperatures in such a way that the color deviations of the current (cumulative) color coordinate are minimal. When the LED's become warmer, controlling takes place on the Planck's plot curve. As a result, at higher temperatures, increased use is made, for example, of yellow and/or green LED's, which present less luminous flux regression than orange-colored and/or red LED's. As a result, even at elevated temperatures (e.g. at an LED operating temperature of 100° C.), a high luminous flux can be attained than with controlling on only the straight Judd lines, for example.

The object is also achieved by a color control device, wherein the color control device is designed to carry out the method in accordance with one of the preceding claims.

The color control device can, for example, be a functioning part of a driver for the semiconductor light sources.

The color control device can, for example, be connected to a temperature sensor for sensing an operating temperature at at least one of the semiconductor light sources, or comprise such a sensor.

The color control device can, for example, comprise a memory for the storing of a control algorithm.

In the following Figures the invention is described in greater detail on the basis of exemplary embodiments presented in diagrammatic form. For easier overview, elements which are the same or have the same effect are provided with the same reference number.

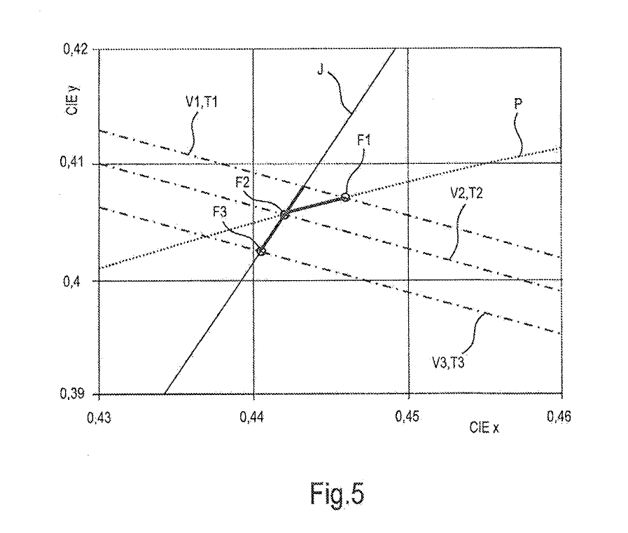

FIG. 5 shows an extract from a CIE diagram for a method according to a first embodiment;

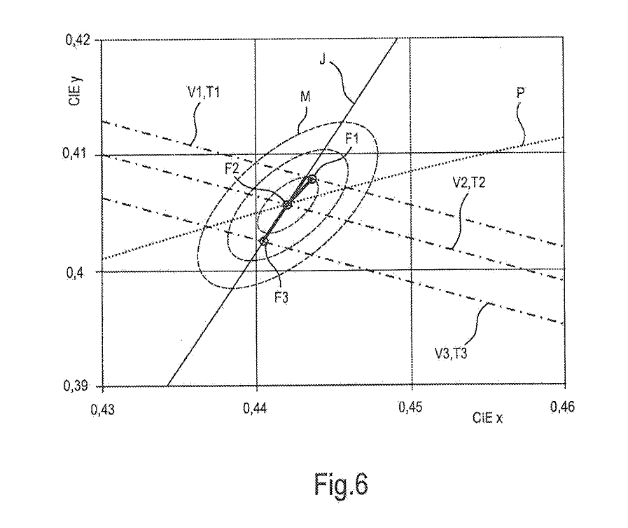

FIG. 6 shows an extract from a CIE diagram for a method according to a second embodiment;

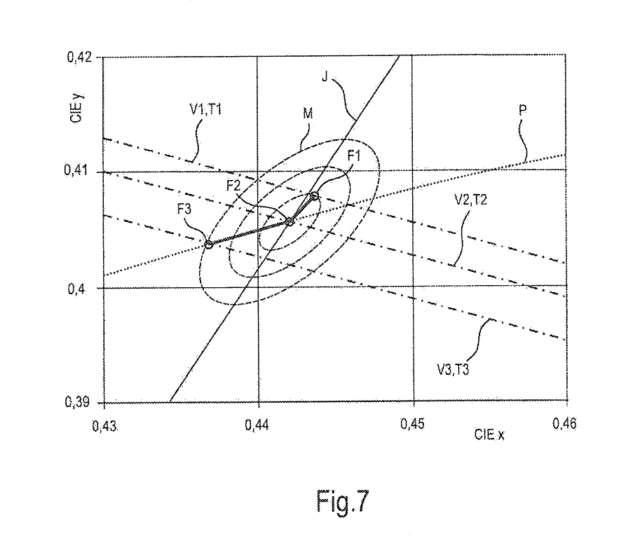

FIG. 7 shows an extract from a CIE diagram for a method according to a third embodiment.

FIG. 5 shows an extract from a CIE diagram for a method according to a first embodiment. This method supports a warm-up behavior of natural appearance of a lighting device with light-emitting diodes or groups thereof, with two different colors.

With cold light-emitting diodes with an initial operating temperature T1 of less than 40° C. (e.g. room temperature), for example in an initial phase or warm-up phase after the lighting device has been switched on, in the first instance a color coordinate is adjusted on the Planck's plot curve P (Planck's Control), and therefore, as the operating temperature rises, a light color is generated as with thermal radiators (e.g. incandescent lamps). This is represented here, by way of example, for the color coordinate F1 on the straight connecting lines V1, relating to the operating temperature T1.

On reaching a color temperature selected as the switchover point (e.g. of a correlated color temperature CCT of 3000 K, in this example reached at an operating temperature of the LED(s) of 80° C.), controlled switchover is then carried out at a point on a straight Judd line J (for 3000 K, for example). The switchover point in this case corresponds to the color coordinate F2 at the minimum operating temperature of T2=80° C. A color coordinate on the straight Judd line J is located in a typical range of an operating temperature of between T=80° C. and T=100° C., corresponding to between F2 and F3. The warmed-up light-emitting diodes then maintain a constant color temperature and merge harmoniously into an ensemble with other sources.

This method sequence, in other words, comprises the step that, in the warm-up phase of, in this example, an LED operating temperature of between less than 40° C. and 80° C., the lighting device exhibits a color behavior similar to that of an incandescent lamp. From reaching the switchover point shortly before or on reaching the minimum nominal operating temperature of, for example, approx. 80° C., the lighting device radiates at a constant color temperature. At excessively high operating temperatures (e.g. of more than 90° C., which corresponds to an exceeding of the maximum nominal operating temperature) or at excessively low operating temperatures (e.g. of less than 80° C., which corresponds to a shortfall of the minimum nominal operating temperature), the color temperature nevertheless remains constant. To achieve this, switchover takes place from the Planck's Control to the Judd Control, but not the other way round, which corresponds to a switchover between the two controls only once for the period during which the lighting device is switched on, and specifically in one direction from below (from a part area of lower temperature values into a part range of higher temperature values than at the switchover point).

FIG. 6 shows an extract from the CIE diagram for a method according to a second embodiment. This method supports a minimum appreciable warm-up behavior of a lighting device with light-emitting diodes or groups thereof, with two different colors.

With cold light-emitting diodes, in the first instance a color coordinate is adjusted on a MacAdam semi-axis (which corresponds to a MacAdam Control) which in this case is represented by way of example by the color coordinate F1. The MacAdam semi-axis intersects the Planck's plot curve P, wherein the point of intersection (which corresponds to the color coordinate F2) corresponds to a desired target color temperature. On or after reaching the Planck's plot curve P at the color coordinate F2, switchover takes place to the straight Judd line J pertaining to the target color temperature. Until the target color temperature is reached, the use of the MacAdam Control results in a minimum visible color displacement, and thereafter, due to the use of the Judd Control, a constant color temperature is maintained. In other words, this corresponds to a MacAdam Control(ling) or adjustment at an operating temperature of up to a nominal operating temperature, followed by a switchover to the Judd Control(ling) or adjustment.

FIG. 7 shows an extract from the CIE diagram for a method according to a third embodiment. This method supports a minimum light flux loss in an initial warm-up phase of a lighting device with light-emitting diodes or groups thereof, with two different colors.

With cold light-emitting diodes, a color coordinate, e.g. F1, is adjusted on the MacAdam semi-axis (MacAdam Control). With the rising operating temperature, as soon as the Planck's plot curve P is intersected at a color coordinate F2, further control takes place on the Planck's plot curve P (Planck Control), as represented here between the color coordinates F2 and F3.

As a result, the at least one LED of a first color (e.g. yellow, green, or yellow-green LED's), which provide(s) a comparatively high light flux, is switched on increasingly or more intensely in comparison with at least one LED of a second color (e.g. orange, red, or orange-red LED's). As a result, at higher temperatures the LED's of the first color are increasingly used, which present a lesser light flux regression than the LED's of the second color. As a result, it is possible even at elevated temperatures (e.g. an LED operating temperature of 100° C.) for a higher light flux to be attained than with the use of a Judd Control.

The preceding invention is naturally not restricted to the exemplary embodiments shown.

Accordingly, more than two controls can be used. Other controls than the controls described may also be used.

In addition, the method can also be applied with more than two colors or, respectively, semiconductor lighting devices with more than two colors, and specifically, for example, in such a way that for a color coordinate, e.g. in a three-dimensional color coordinate, first the desired cumulative color coordinate in a two-dimensional color space (for two colors) is adjusted, and then in a further two-dimensional color space, wherein the axes now represent the third color on the one hand, and the previously-adjusted cumulative color on the other. The two two-dimensional color spaces can overall form or encompass the three-dimensional color space of the three original colors.

### REFERENCE NUMBER LIST

V1 Straight connecting line
V2 Straight connecting line
V3 Straight connecting line
T LED temperature
T1 Temperature
T2 Temperature
T3 Temperature
F1 Color coordinate
F2 Color coordinate
F3 Color coordinate
M MacAdam ellipse
P Planck's plot curve
J Judd straight line

1. A method for operating a semiconductor lighting device, wherein the semiconductor lighting device comprises semiconductor light sources having at least two different colors and wherein, in order to adjust a color coordinate of the semiconductor lighting device, at least one brightness of the semiconductor light sources is set by means of a control and
wherein the at least one brightness of the semiconductor light sources is adjusted by at least two controls, and wherein, upon reaching or exceeding at least one predetermined switchover point, a switchover is made between two of the controls.

2. The method as claimed in claim 1, wherein the controls are selected from a group, which comprises:
a) an adjustment of the color coordinate of the semiconductor light source onto a position on a straight Judd line,
b) an adjustment of the color coordinate of the semiconductor light source onto a semi-axis of a MacAdam ellipse, and/or
c) an adjustment of the color coordinate of the semiconductor light source onto a position on the Planck's plot curve.

3. The method as claimed in claim 2, wherein the switchover point correlates with a temperature at at least one of the semiconductor light sources.

4. The method as claimed in claim 2, wherein the switchover point correlates with a color coordinate.

5. The method as claimed in claim 4, wherein the switchover is carried out only on reaching the switchover point from one direction or exceeding it in one direction.

6. The method as claimed in claim 1, wherein the switchover is carried out between two control devices once for the duration of the lighting device being switched on.

7. The method as claimed in claim 1, wherein the switchover is carried out on reaching the switchover point from both directions or exceeding it in both directions.

8. The method as claimed in claim 7, wherein the switchover is carried out depending on the direction, with different switchover points.

9. The method as claimed in claim 8, wherein the different switchover points form a hysteresis of approximately 5° C. to 10° C.

10. The method as claimed in claim 3, wherein the color coordinate is initially adjusted onto a position on the Planck's plot curve and, on reaching or exceeding a predetermined color temperature and/or the temperature, switchover takes place at at least one of the semiconductor light sources onto a position on a straight Judd line.

11. The method as claimed in claim 5, wherein the color coordinate is initially adjusted onto a position on a semi-axis of a MacAdam ellipse, and, on reaching or exceeding a point of intersection with the Planck's plot curve, switchover takes place onto a position on a straight Judd line.

12. The method as claimed in claim 6, wherein switchover is carried out between the two controls at an operating temperature at at least one of the semiconductor light sources shortly before or upon reaching an operating temperature.

13. The method as claimed in claim 5, wherein the color coordinate is initially adjusted onto a position on a semi-axis of a MacAdam ellipse, and, on reaching or exceeding a point of intersection with the Planck's plot curve, switchover takes place onto a position on the Planck's plot curve.

14. A color control device, wherein the color control device is designed to carry out the method as claimed in claim 1.

15. The method as claimed in claim 2, wherein said semi-axis is a large semi-axis of a MacAdam ellipse.

16. The method as claimed in claim 12, wherein said operating temperature is approximately 80° C.
